(19) United States
(12) Patent Application Publication
(10) Pub. No.: US 2003/0095380 A1
(43) Pub. Date: May 22, 2003

(54) Expansion station for personal digital assistants

(75) Inventors: Ping-Hsin Chen, Taipei City (TW); Chuan-Yuan Lee, Taipei City (TW); Shing-Beng Wu, Taipei City (TW)

Correspondence Address: FOLEY AND LARDNER, SUITE 500, 3000 K STREET NW, WASHINGTON, DC, 20007, US

(73) Assignee: COMPAL ELECTRONICS, INC.

(21) Appl. No.: 09/987,864

(22) Filed: Nov. 16, 2001

(51) Int. Cl. G06F 1/16

(52) U.S. Cl. 361/686; 361/680; 361/683

(57) ABSTRACT

An expansion station for a personal digital assistant includes a keyboard module, an internal circuit, an interface port unit, a cover module, and an I/O connector. The internal circuit is mounted in the keyboard module and is connected electrically to a keypad unit of the keyboard module. The interface port unit is mounted on the keyboard module and is connected electrically to the internal circuit. A positioning space is configured in an inner surface of the cover module for positioning removably the personal digital assistant therein. The I/O connector is disposed in the positioning space and is adapted to engage an I/O port of the personal digital assistant so that electrical connection between the personal digital assistant and the interface port unit is established via the I/O connector and the internal circuit.

### BACKGROUND OF THE INVENTION

1. Field of the Invention

The invention relates to an expansion station for personal digital assistants, more particularly to an expansion station for personal digital assistants that has an interface port unit to facilitate connection of the personal digital assistant to peripheral equipment, such as a scanner, a printer, a personal computer, etc.

2. Description of the Related Art

Conventional personal digital assistants are not provided with a large number of interface ports for simultaneous connection with a variety of peripheral equipment. U.S. Pat. No. 6,108,200 discloses a handheld computer keyboard system for use in conjunction with small computerized apparatus, such as personal digital assistants. The handheld computer keyboard system disclosed in this U.S. patent includes a keyboard, a cover, and an I/O connector for connecting electrically the computerized apparatus to the keyboard system. However, the handheld computer keyboard system of this prior art is merely an input system for inputting text and data into the computerized apparatus, and lacks the facility for connecting the computerized apparatus to other peripheral equipment, such as scanners, printers, personal computers, etc.

### SUMMARY OF THE INVENTION

Therefore, the object of the present invention is to provide an expansion station for personal digital assistants that has an interface port unit to facilitate connection of the personal digital assistant to peripheral equipment.

Accordingly, the expansion station for a personal digital assistant with an I/O port of this invention includes a keyboard module, an internal circuit, an interface port unit, a cover module, and an I/O connector. The keyboard module has a top side provided with a keypad unit, a bottom side adapted to be placed on a table surface, a front end, and a rear end. The internal circuit is mounted in the keyboard module and is connected electrically to the keypad unit. The interface port unit is mounted on the keyboard module and is connected electrically to the internal circuit. The interface port unit includes at least one of a USB port, a RS-232 port, a VGA output port and a power input port. The cover module has an inner surface and an outer surface. The cover module is coupled proximate to the rear end of the keyboard module such that the cover module is pivotable from a closed position, where the inner surface overlies the keyboard module, to an open position, where the cover module is oriented at an angle relative to the keyboard module. The inner surface is configured with a positioning space adapted for positioning removably the personal digital assistant therein. The I/O connector is mounted on the cover module and is connected electrically to the internal circuit. The I/O connector is disposed in the positioning space and is adapted to engage the I/O port of the personal digital assistant so that electrical connection between the personal digital assistant and the interface port unit is established via the I/O connector and the internal circuit.

### BRIEF DESCRIPTION OF THE DRAWINGS

Other features and advantages of the present invention will become apparent in the following detailed description of the preferred embodiment with reference to the accompanying drawings, of which:

FIG. 1 is a perspective view of the preferred embodiment of an extension station for personal digital assistants according to this invention;

FIG. 2 is a rear view of the preferred embodiment;

FIG. 3 is a perspective view showing how a personal digital assistant is positioned in a positioning space of a cover module of the preferred embodiment;

FIG. 4 is a bottom view of the personal digital assistant;

FIG. 5 is a perspective view showing a state where the personal digital assistant is positioned in the positioning space of the cover module and is connected electrically to an I/O connector on the cover module;

FIG. 6 is a side view of the preferred embodiment in a state of use; and

FIG. 7 is a schematic circuit block diagram of the preferred embodiment.

### DETAILED DESCRIPTION OF THE PREFERRED EMBODIMENT

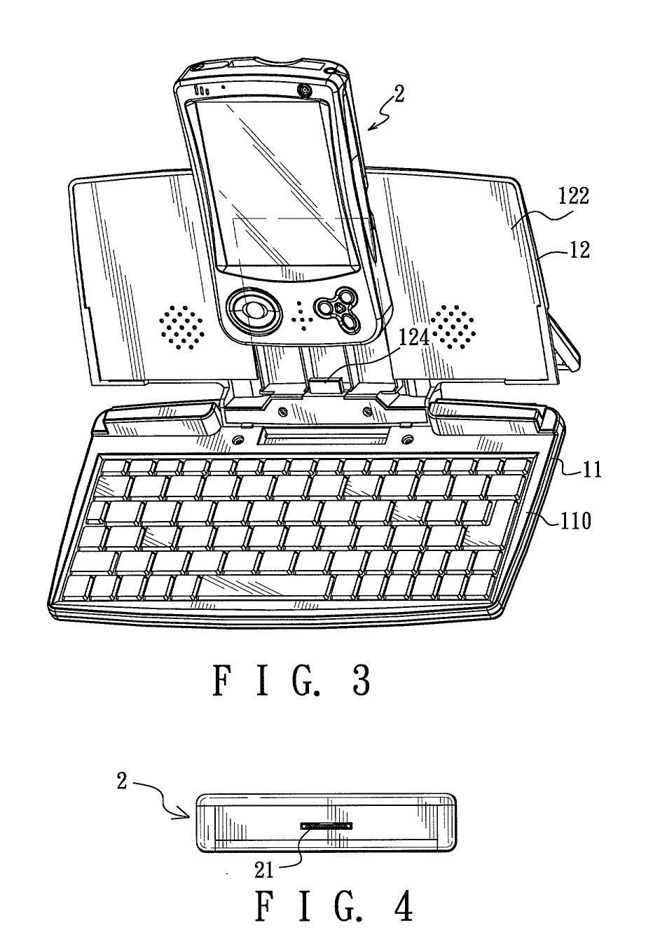

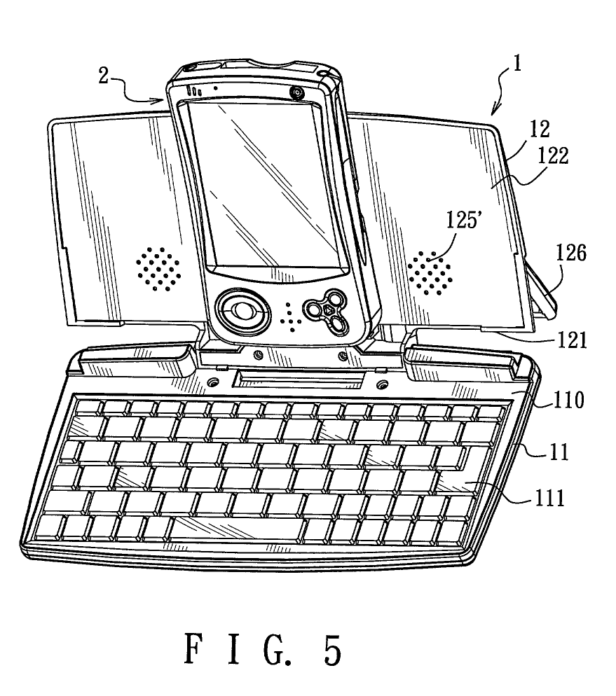

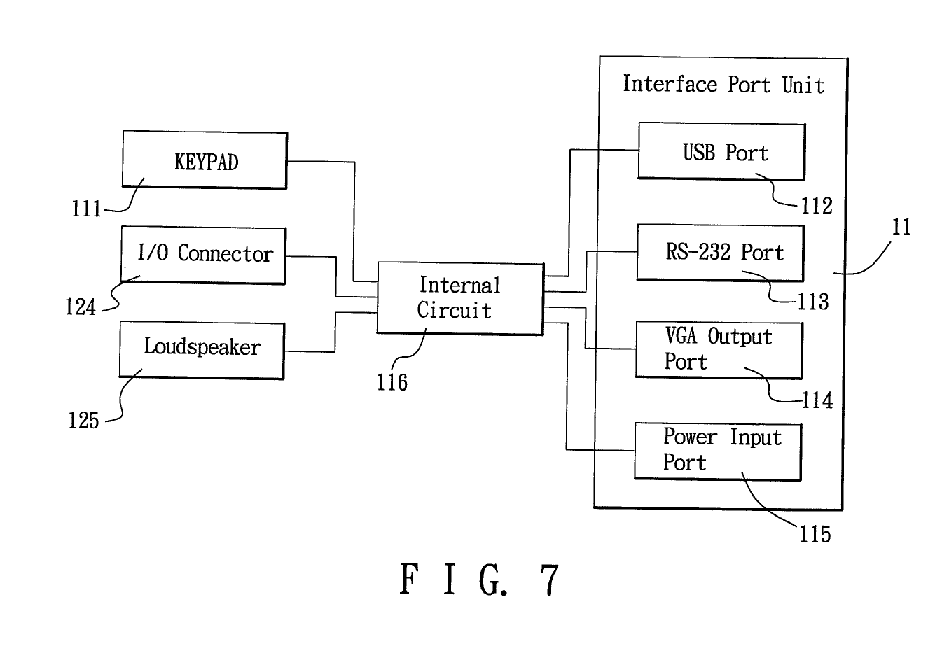

Referring to FIGS. 1, 2, 3, 5 and 7, the preferred embodiment of an expansion station 1 for personal digital assistants 2 with an I/O port 21 (see FIG. 4) according to this invention is shown to include a keyboard module 11, an internal circuit 116, an interface port unit 11′, a cover module 12, and an I/O connector 124.

The keyboard module 11 has a top side 110 provided with a keypad unit 111, a bottom side 111′ adapted to be placed on a table surface, a front end 111a, and a rear end 111b.

The internal circuit 116 is mounted in the keyboard module 11 and is connected electrically to the keypad unit 111. The interface port unit 11′ is mounted on the rear end 111b of the keyboard module 11 and is connected electrically to the internal circuit 116. In this embodiment, the interface port unit 11′ includes a USB port 112, an RS-232 port 113, a VGA output port 114 and a power input port 115. When the personal digital assistant 2 is connected electrically to the expansion station 1 through the I/O connector 124 of the expansion station 1, the USB port 112 can serve as a connecting port for connecting electrically the personal digital assistant 2 to external peripheral equipment having a USB interface (such as, scanners, hard disk drivers, floppy disk drivers, printers, modems, etc.) via the I/O connector 124, the internal circuit 116 and the USB port 112. The RS-232 port 113 can serve as a connecting port for connecting electrically the personal digital assistant 2 to external peripheral equipment having an RS-232 interface (such as, personal computers, printers, etc.) via the I/O connector 124, the internal circuit 116 and the RS-232 port 113. The VGA output port 114 can serve as a connecting port for connecting electrically the personal digital assistant 2 to an external monitor via the I/O connector 124, the internal circuit 116 and the VGA output port 114. The power input port 115 can serve as a connecting port for connecting electrically the personal digital assistant 2 to a power supply source via the I/O connector 124, the internal circuit 116, the power input port 115 and a power adapter. Therefore, the expansion station 1 can permit simultaneous connection of the personal digital assistant 2 to a variety of peripheral equipment via the interface port unit 11′.

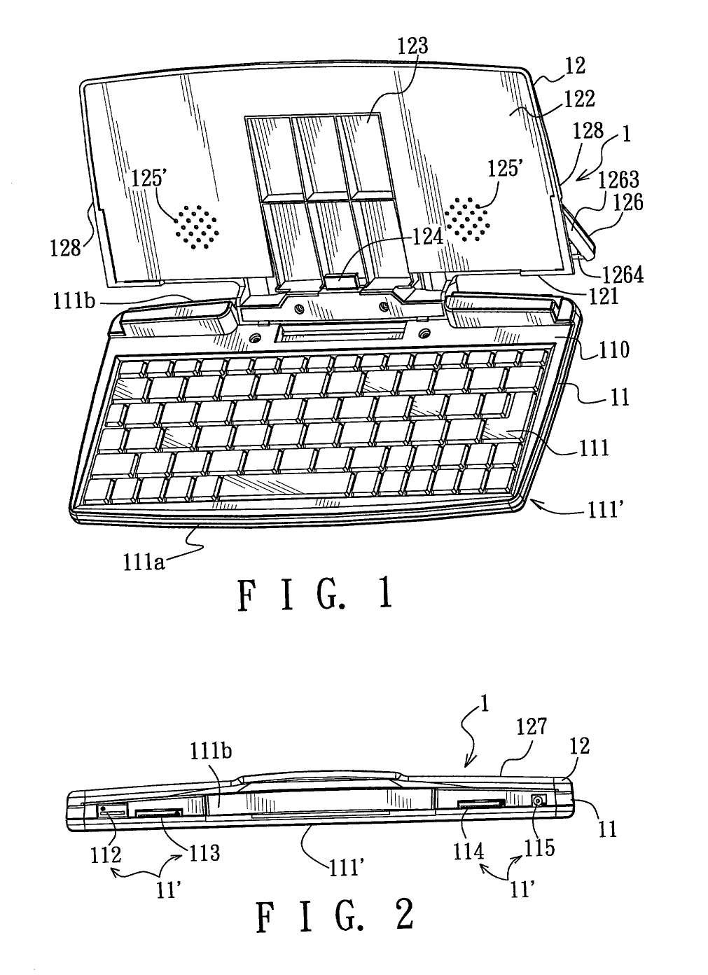

The cover module 12 has an inner surface 122 and an outer surface 127. The cover module 12 is coupled proximate to the rear end 111b of the keyboard module 11 such that the cover module 12 is pivotable from a closed position shown in FIG. 2, where the inner surface 122 overlies the keyboard module 11, to an open position shown in FIG. 1, where the cover module 12 is oriented at an angle relative to the keyboard module 11. The inner surface 122 is configured with a positioning space 123 adapted for positioning removably the personal digital assistant 2 therein.

The I/O connector 124 is mounted on the cover module 12 and is connected electrically to the internal circuit 116. Referring to FIGS. 1, 3, 4 and 5, the I/O connector 124 is disposed in the positioning space 123 and is adapted to engage the I/O port 21 of the personal digital assistant 2 so that electrical connection between the personal digital assistant 2 and the interface port unit 11′ is established via the I/O connector 124 and the internal circuit 116. Preferably, the I/O connector 124 of the expansion station 1 is replaceable to suit the I/O port 21 of the personal digital assistant 2 so as to enable the expansion station 1 to be adapted for use with various personal digital assistants 2.

Preferably, a loudspeaker unit 125 is mounted in the cover module 12 and is connected electrically to the internal circuit 116 so that electrical connection between the personal digital assistant 2 and the loudspeaker unit 125 is established via the I/O connector 124 and the internal circuit 116. Additionally, the inner surface 122 of the cover module 12 is formed with sound holes 125′ that are registered with the loudspeaker unit 125. The loudspeaker unit 125 permits audible reproduction of MP3 files from the personal digital assistant 2.

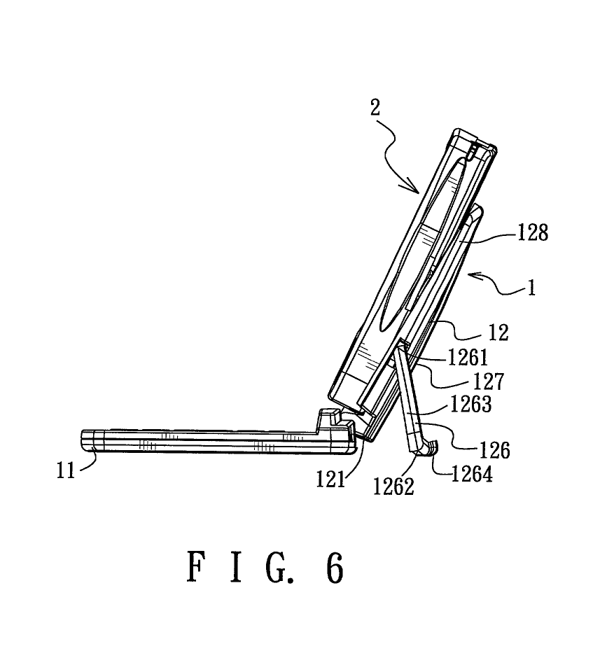

Referring to FIGS. 1 and 6, the expansion station 1 further includes a stand 126 having a pivot end 1261 coupled to the cover module 12 and a support end 1262. The stand 126 is pivotable from a retracted position, where the support end 1262 is disposed proximate to the cover module 12, to a support position, where the support end 1262 is angularly spaced apart from the outer surface 127 of the cover module 12 and is adapted to support the cover module 12 on the table surface when the cover module 2 is at the open position. Moreover, the cover module 12 has opposite lateral sides 128 and a rear side 121 extending between the opposite lateral sides 128. The stand 126 is generally U-shaped and has a pair of arm segments 1263 formed with the pivot end 1261, and a bridging segment 1264 interconnecting the arm segments 1263 and formed with the support end 1262. The arm segments 1263 are disposed adjacent to the lateral sides 128 of the cover module 12 and the bridging segment 1264 extends adjacent to the rear side 121 of the cover module 12 when the stand 126 is at the retracted position.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

We claim:

1. An expansion station for a personal digital assistant with an I/O port, said expansion station comprising:
a keyboard module having a top side provided with a keypad unit, a bottom side adapted to be placed on a table surface, a front end, and a rear end;
an internal circuit mounted in said keyboard module and connected electrically to said keypad unit;
an interface port unit mounted on said keyboard module and connected electrically to said internal circuit, said interface port unit including at least one of a USB port, a RS-232 port, a VGA output port and a power input port;
a cover module having an inner surface and an outer surface, said cover module being coupled proximate to said rear end of said keyboard module such that said cover module is pivotable from a closed position, where said inner surface overlies said keyboard module, to an open position, where said cover module is oriented at an angle relative to said keyboard module, said inner surface being configured with a positioning space adapted for positioning removably the personal digital assistant therein; and
an I/O connector mounted on said cover module and connected electrically to said internal circuit, said I/O connector being disposed in said positioning space and being adapted to engage the I/O port of the personal digital assistant so that electrical connection between the personal digital assistant and said interface port unit is established via said I/O connector and said internal circuit.

2. The expansion station as claimed in claim 1, further comprising a loudspeaker unit mounted on said cover module and connected electrically to said internal circuit so that electrical connection between the personal digital assistant and said loudspeaker unit is established via said I/O connector and said internal circuit.

3. The expansion station as claimed in claim 2, wherein said loudspeaker unit is mounted in said cover module, and said inner surface is formed with sound holes that are registered with said loudspeaker unit.

4. The expansion station as claimed in claim 1, further comprising a stand having a pivot end coupled to said cover module and a support end, said stand being pivotable from a retracted position, where said support end is disposed proximate to said cover module, to a support position, where said support end is angularly spaced apart from said outer surface and is adapted to support said cover module on the table surface when said cover module is at the open position.

5. The expansion station as claimed in claim 4, wherein:
said cover module has opposite lateral sides and a rear side extending between said opposite lateral sides;
said stand being generally U-shaped and having a pair of arm segments formed with said pivot end, and a bridging segment interconnecting said arm segments and formed with said support end, said arm segments being disposed adjacent to said lateral sides and said bridging segment extending adjacent to said rear side when said stand is at the retracted position.
